(19) United States
(12) Patent Application Publication
(10) Pub. No.: US 2006/0147155 A1
(43) Pub. Date: Jul. 6, 2006

(54) Double sided optical adaptor

(76) Inventors: Carl Fattal, San Francisco, CA (US); Jihad Najem, Union City, CA (US)

Correspondence Address: MAYER & WILLIAMS PC, 251 NORTH AVENUE WEST, 2ND FLOOR, WESTFIELD, NJ, 07090, US

(21) Appl. No.: 11/027,571

(22) Filed: Dec. 30, 2004

(51) Int. Cl. G02B 6/36

(52) U.S. Cl. 385/53; 385/92

(57) ABSTRACT

An opto-electronic device includes a chassis having a backplane, at least one opto-electronic component housed in the chassis, and an optical cable optically coupled to the opto-electronic component. The backplane has a thru-hole through which the optical cable extends to an exterior of the chassis. An optical fiber adaptor is provided for communicating optical signals between an external device and the opto-electronic component housed in the chassis. The optical fiber adaptor includes a housing assembly secured to an exterior of the backplane of the chassis, at least one external optical mating element located in the housing assembly for engaging with a complementary mating element of the external device, and at least one internal optical mating element located in the housing assembly. The optical cable has a complementary mating element for engaging with the internal optical mating element. The internal and external optical mating elements are located external to the chassis.

### BACKGROUND OF THE INVENTION

1. Field of the Invention

The present invention generally relates to an optical adaptor, and more particularly to a double sided optical adaptor for coupling opto-electronic devices to each other.

2. Description of the Related Art

The use of optical fibers for high-volume high-speed communication is well established. As the volume of transmitted information grows, the use of optical fiber cables including multiple optical fibers, and of systems using multiple optical fiber cables, has increased.

The design of traditional electronic cabinets is now being utilized to accommodate optical and opto-electronic devices. In traditional cabinet designs, the cabinet comprises a box having a plurality of internal slots or racks, generally parallel to each other. Components are mounted on circuit boards, which are designed to slide into the slots or racks within the cabinet.

As with electrical cables, the need exists to provide a means to allow the optical signals from an external device to be passed through the backplane of electronic cabinets. Conventional arrangements employ an optical fiber adaptor that is secured to the backplane of the cabinet. The adaptor mates with an internal optical connector that extends within the cabinet and which communicates the optical signal to a circuit board located in the cabinet. The opposing side of the optical fiber adaptor mates with an external connector that conveys the optical signal between the external device and the internal connector. Generally only the external connector is accessible to the user since the internal connector feeds directly into the cabinet via the backplane.

Since a conventional optical fiber adaptor only has a connector that is accessible on one side, it can be cumbersome to clean, test, replace or reconfigure the optical fibers. Often, a special tool is needed to access the optical fibers. Moreover, despite the use of a special tool, the optical fiber adaptor sometimes must be replaced after such access is achieved.

Accordingly, it would be desirable to provide an optical fiber adaptor for a cabinet that houses optical or opto-electronic components in which both the optical connections to the internal components and the optical connections to an external device are easily accessible to a user.

### SUMMARY OF THE INVENTION

In accordance with the present invention, an opto-electronic device is provided. The device includes a chassis having a backplane, at least one opto-electronic component housed in the chassis, and an optical cable optically coupled to the opto-electronic component. The backplane has a thru-hole through which the optical cable extends to an exterior of the chassis. An optical fiber adaptor is provided for communicating optical signals between an external device and the opto-electronic component housed in the chassis. The optical fiber adaptor includes a housing assembly secured to an exterior of the backplane of the chassis, at least one external optical mating element located in the housing assembly for engaging with a complementary mating element of the external device, and at least one internal optical mating element located in the housing assembly. The optical cable has a complementary mating element for engaging with the internal optical mating element. The internal and external optical mating elements are located external to the chassis.

In accordance with one aspect of the invention, the internal and external optical mating elements are located on opposing sides of the housing assembly.

In accordance with another aspect of the invention, the internal and external optical mating elements receive their respective complementary mating elements along a common line parallel to a plane in which the backplane extends.

In accordance with another aspect of the invention a cover is provided that encloses at least a portion of the housing assembly in which the internal optical mating element is located.

In accordance with another aspect of the invention, a cover is provided that encloses a portion of the housing assembly in which the internal optical mating element is located while the external mating element remains exposed.

### BRIEF DESCRIPTION OF THE DRAWINGS

For a more complete understanding of the present invention and the advantages thereof, reference is now made to the following descriptions taken in conjunction with the accompanying drawings which illustrate the embodiments of the present invention, wherein:

FIG. 1 illustrates a double sided optical adaptor mounted on an opto-electronic device.

FIG. 2 illustrates a cross-sectional view of a double sided optical adaptor.

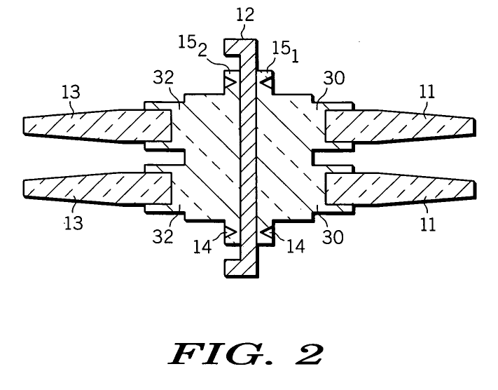

### DETAILED DESCRIPTION OF THE PREFERRED EMBODIMENTS

Hereinafter, an embodiment of the present invention will be described with reference to the drawings.

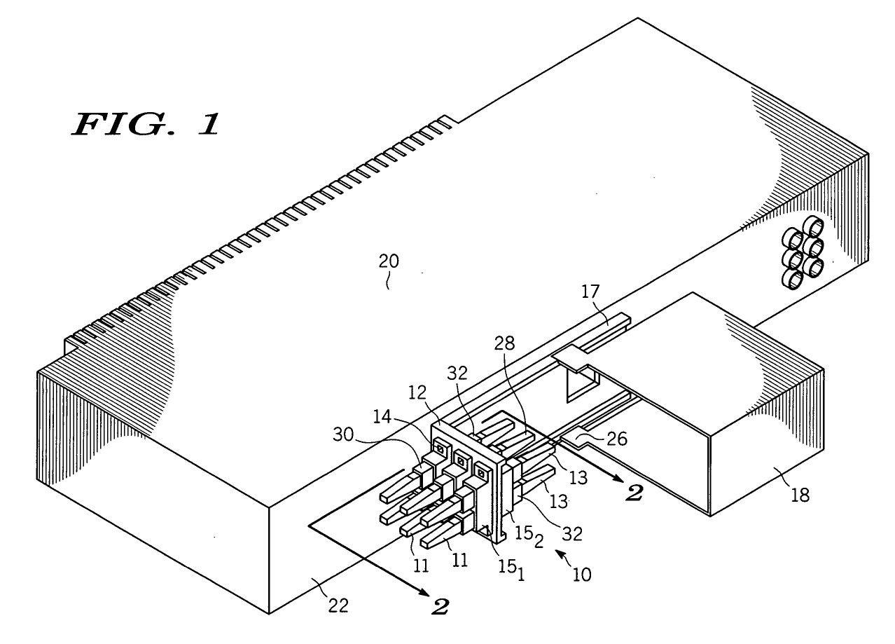

FIG. 1 illustrates an embodiment of a double sided optical fiber adaptor 10 in accordance with the present invention. The double sided optical adaptor 10 couples to a circuit card or cards (not shown) located within a chassis 20. The circuit card(s) may include optical, optoelectronic and electronic components. The optical adaptor 10 facilitates the communication of optical signals between an external opto-electronic device and the circuit card(s) via a backplane 22 of the chassis. A backplane derives its name from the back (distal) plane in a parallelepipedal cabinet and generally is orthogonal to the circuit card(s). The term backplane in the present invention refers to an interconnection plane where a multiplicity of interconnections may be made, such as with a common bus or other external devices. For explanation purposes, a backplane is described as having a front or interior face and a back or exterior face. The backplane 22 may be situated on any surface of the chassis 20, including top, bottom and side walls.

The optical adaptor 10 includes a housing assembly 15. In the particular embodiment of the invention depicted in the figures, housing assembly 15 is formed from two housing members 15₁ and 15₂. In some embodiments, the housing members 15₁ and 15₂ are formed from molded plastic pieces of a dielectric material that exhibit the structural strength and dimensional stability required to maintain control of the optical fiber's position. Such materials include, but are not limited to, thermoplastic injection moldable polymers that are filled or unfilled with reinforcement agents, and transfer moldable polymers such as epoxy.

Each of the housing members 15₁ and 15₂ contain mating features corresponding to common plugs or ferrules. For example, in the illustrated embodiment the mating features are depicted as a multiplicity of receptacles 30 and 32. Receptacles 30 are external receptacles designed to mate with a plug or ferrule 11 from an external device. Receptacles 32 are internal receptacles designed to mate with a plug or ferrule 13 of an optical cable 26 that is connected to the internal circuit card(s). Cables 26 extend through a thru-hole 28 in the backplane 22 of the chassis 20.

Receptacles 30 and 32 may be configured to accept plugs conforming to any type of optical connector. For example, the connectors may be commercially available connectors including, without limitation, SC/APC, SC/PC, FC/APC, FC/PC, and ST connectors.

One important feature of the present invention is that because the optical adaptor 10 has both external mating features (e.g., receptacles 30) and internal mating features (e.g., receptacles 32) that are readily accessible to the user, the optical fibers on both sides of the adaptor 10 can be easily cleaned, tested, replaced, or the like without the use of any special tools are equipment.

The optical adaptor 10 may be mounted to the exterior surface of the backplane 22 in any convenient manner. As shown, for example, housing assembly 15 includes a flange 12 that extends radially outward from the external surface of the backplane. The housing members 15₁ and 15₂ are secured to opposing sides of the flange 12. In this way the connectors plugs that engage with the receptacles 11 and 13 can be situated parallel to the backplane 22, thereby providing easy accessibility. The housing members 15₁ and 15₂ may be secured to flange 12 using any of a variety of fastening mechanisms 14, including bolts, mounting screws, adhesives and other devices known in the art. Flange 12 is secured to backplane 22 via mounting bracket 17. Of course, the present invention encompasses any type of bracket or other means of securing the optical adaptor 10 to the exterior surface of the backplane. Moreover, the optical adaptor 10 may be secured to the backplane 22 in any desired orientation and is not limited to the orientation depicted in the figures.

As shown in FIG. 1, an optional connector cover 18 may be provided to protect the optical adaptor and the connectors from external physical impact. The connector cover 18 may enclose the optical adaptor 10 and the connectors while being secured to the bracket 17. In other embodiments the connector cover 18 may be secured to the optical adaptor 10 itself or the backplane 22. In some embodiments of the invention the connector cover 18 may only enclose the internal connectors 13, thereby leaving the external connectors 11 exposed so that easily accessed.

Although the present invention and its advantage have been described in detail, it should be understood that various changes, substitutions and alternations can be made herein without departing from the spirit and scope of the invention as defined by the appended claims.

What is claimed is:

1. An optical fiber adaptor for communicating optical signals between an external device and an opto-electronic component housed in a chassis, comprising:
a housing assembly adapted to be secured to an exterior of a backplane of a chassis;
at least one external optical mating element located in the housing assembly for engaging with a complementary mating element of the external device; and
at least one internal optical mating element located in the housing assembly for engaging with a complementary mating element of an optical cable optically coupled to the opto-electronic component housed in the chassis, wherein said internal and external optical mating elements are located external to the chassis when the housing assembly is secured to the exterior of the backplane.

2. The optical fiber adaptor of claim 1 wherein said at least one external mating element is a receptacle for receiving a connector plug.

3. The optical fiber adaptor of claim 1 wherein said at least one internal mating element is a receptacle for receiving a connector plug.

4. An opto-electronic device, comprising:
a chassis having a backplane;
at least one opto-electronic component housed in the chassis;
an optical cable optically coupled to the opto-electronic component, said backplane having a thru-hole through which the optical cable extends to an exterior of the chassis;
an optical fiber adaptor for communicating optical signals between an external device and the opto-electronic component housed in the chassis, said optical fiber adaptor including:
a housing assembly secured to an exterior of the backplane of the chassis;
at least one external optical mating element located in the housing assembly for engaging with a complementary mating element of the external device; and
at least one internal optical mating element located in the housing assembly, said optical cable having a complementary mating element for engaging with the internal optical mating element; and
wherein said internal and external optical mating elements are located external to the chassis.

5. The opto-electronic device of claim 4 wherein said internal and said external optical mating elements are located on opposing sides of the housing assembly.

6. The opto-electronic device of claim 4 wherein said internal and said external optical mating elements receive their respective complementary mating elements along a common line parallel to a plane in which the backplane extends.

7. The opto-electronic device of claim 4 further comprising a cover enclosing at least a portion of the housing assembly in which said at least one internal optical mating element is located.

8. The opto-electronic device of claim 4 further comprising a cover enclosing a portion of the housing assembly in which said at least one internal optical mating element is located while said at least one external mating element remains exposed.
